(19) United States
(12) Patent Application Publication
(10) Pub. No.: US 2011/0010075 A1
(43) Pub. Date: Jan. 13, 2011

(54) METHOD, APPARATUS, AND SYSTEM TO MEASURE, RECORD, AND CONTROL EXHAUST PRODUCTS FROM AN ICE

(76) Inventors: Noah Rogers, Queen Creek, AZ (US); Aaron Stuart, Ogden, UT (US); Chad Buttars, Ogden, UT (US)

Correspondence Address: Steven L. Rinehart, 1059 E. Millstream Way, Bountiful, UT, 84010, US

(21) Appl. No.: 12/500,795

(22) Filed: Jul. 10, 2009

(51) Int. Cl. F02D 41/00; G01M 15/10

(52) U.S. Cl. 701/103; 73/114.42

(57) ABSTRACT

A method, apparatus, and system to measure, record, and control exhaust products from an internal combustion engine (ICE) are disclosed. Measurements of the exhaust products of an ICE are recorded and made available. The measurements provide the inputs for one of a variety of different algorithms to determine the proper flow rates for a first and a for second fuel being feed to an ICE to achieve one or more goals relating to at least one of the measured exhaust products. These flow rates are then enforced to control the exhaust products.

### BACKGROUND

1. Field of the Invention

This invention relates to the efficient operation of internal combustion engine (ICE) emission control systems, and more particularly relates to the use of exhaust sensors to measure and record exhaust products and to control those exhaust products by controlling the ratios of a first and a second fuel supplied to ICEs.

2. Background of the Invention

The ubiquity of internal combustion engines (ICEs) makes their byproducts an important concern. Unfortunately, science assigns to many of these byproducts harmful effects for human health and for the environment. Science also raises grave concerns about possible additional deleterious effects, not yet fully ascertained in scope, such as the possible effects stemming from climate change. These harmful and dangerous byproducts reside in the gases and particulate matter that comprise the exhaust of internal combustion engines.

The fuel burned by an internal combustion engine determines the constituent gasses and particulates found in that engine's exhaust. Gasoline and diesel fueled vehicles produce, by far, the most metric tons of internal combustion exhaust. Unfortunately these fuels result in a large variety of harmful gasses and particulates in the exhaust they produce.

Examples of detrimental exhaust products from gasoline and diesel include, but are not limited to: carbon monoxide (CO), carbon dioxide (CO₂), nitrogen monoxide (NO), nitrous oxide (NO₂), sulfur dioxide (SO₂), hydrocarbons, such as benzene and polycyclic aromatic hydrocarbons (PAFs), and particulate matter. Carbon monoxide (CO), caused from incomplete combustion, reduces the ability of blood to carry oxygen, exacerbates diseases of the heart and lungs, and causes fatigue, dizziness and headaches. Scientific research points to CO₂ as the primary contributor to climate change because of its demonstrated behavior of trapping electromagnetic energy from the sun.

Both nitrogen oxides (NO and NO₂) and, especially SO₂, cause acid rain. Additionally, both nitrogen oxides (NO and NO₂) form a yellowish-brown haze and combine with oxygen to produce a gas that damages lung tissue. Additionally, nitrogen oxides combine with hydrocarbons to form ozone (O₃), which produces a white haze that decreases lung capacity and can cause lung diseases such as asthma. Furthermore, NO₂, like CO₂, traps electromagnetic energy in the atmosphere.

As mentioned, hydrocarbons play an important role in ozone formation. Many hydrocarbons, such as benzene and many of the PAHS are known toxins and cancer causing carcinogens. Particulates cause lung damage and can include toxins and carcinogens.

Several alternate fuels offer the promise of reducing some or all of these detrimental exhaust products. Natural gas, both compressed and liquid, and propane figure prominently among these. Additional alternatives fuels include hydrogen, liquid nitrogen, and compressed air. Further examples include hydrogen enhanced fuels, biomass fuels, and alcohol fuels, among others.

Unfortunately, alternative fuels tend to burn at high temperatures that can damage engines, exhaust systems, and surrounding components. This is particularly true for engines that have been designed for traditional fuels, even after retrofitting takes place. Running entirely on alternative fuels, therefore, presents additional mechanical problems.

Furthermore, the infrastructure does not presently exist to make such fuels readily available to the consuming public. Additionally, alternative fuels require larger, and often pressurized, storage tanks, permitting reduced travel ranges. Importantly, the availability of alternative fuels is an obstacle to supplanting traditional fuels with alternative fuels. For example, most supplies of natural gas in the United States are already allocated to home heating and the production of electricity and a reliable method for the production source of hydrogen has yet to be discovered.

Practical considerations dictate, therefore, that emission reductions through the use of alternative fuels must be achieved in stages. To accommodate this reality, innovators have designed ICEs capable of running on both traditional fuels and alternative fuels at the same time. Furthermore with some modification, ICEs not originally designed to run on a combination of traditional and alternative fuels can be altered to run on two fuels, allowing for the gradual introduction of alternative fuels to the public. However, without proper controls, the addition of the second fuel may even make emissions worse.

The ratio of fuels delivered to ICEs manifests itself in terms of both performance metrics and exhaust products. Over time, several refinements have been made to the drive systems of ICEs that run on multiple fuels, resulting in systems that rely on feedback from system sensors to optimize the fuel ratios to ensure or approach desired performance metrics. However, these improvements do not capitalize on the ability of ICEs to reduce harmful exhaust products.

As discussed above, internal combustion engines produce a number of different exhaust products that, at different levels, adversely affect different aspects of human health and the environment in varying degrees. Over time, an understanding of the impact of these exhaust products has evolved and continues to evolve. For example, the Environmental Protection Agency (EPA) once characterized CO₂ as a product of “perfect” combustion. Now, CO₂ may become regulated as a greenhouse gas. Despite improving understanding as to the effects of various levels of exhaust products, presently, there exists no way to measure and control levels of individual exhaust products in real time.

In view of the foregoing, what is needed are a method, apparatus and system to measure and to record exhaust products from ICEs in real time. Such a method, apparatus, and system would also control exhaust products by controlling the ratio of fuels feed to ICEs based on measurement information. Ideally such an apparatus, system, and method would make the measurements available to interested parties, such as the driver of a vehicle and the EPA, in real time.

### SUMMARY

The invention has been developed in response to the present state of the art and, in particular, in response to the problems and needs in the art that have not yet been fully solved by currently available methods, apparatai, and systems. Accordingly, the invention has been developed to provide improved a method, an apparatus, and a systems to measure, record, and control, exhaust products from an ICE. The features and advantages of the invention will become more fully apparent from the following description and appended claims, or may be learned by practice of the invention as set forth hereinafter.

Consistent with the foregoing, a method for measuring, recording, and controlling exhaust products from ICEs is disclosed herein. In certain embodiments, such a method may include measuring, in real time, potentially harmful exhaust products from an ICE. These measurements of exhaust products become the basis for a determination of appropriate flow rate values for a first fuel and a second fuel fed to an ICE to achieve a goal regarding the presence of one or more exhaust products. These flow rate values are then implemented to control the flow rates of the first and second fuel.

The method may further include increasing the second flow rate for the second fuel relative to the first flow rate for the first fuel. Additional measurements may then be made, including measurements of exhaust temperature. The measurements may then be compared to determine whether there has been a cessation in progress toward the goal regarding one or more exhaust products or if the exhaust temperature has exceeded a safety threshold, to determine when to stop increasing the ratio of the second fuel relative to the first. The increments by which the second fuel is increased relative to the first may be determined with reference to calibration measurements of exhaust products taken when known ratios of the two fuels are combusted after an ICE has been allowed to ideal for a period.

The flow rate of the first fuel may be controlled by interrupting an oxygen sensor, pre-existing or added after the fact, communicatively coupled to an electronic control unit controlling the first fuel rate to achieve a stoichiometric ratio. The method may continue by determining a false oxygen reading that will produce the desired flow rate. This false oxygen reading is then relayed to the electronic control unit. The method may also include storing a record of measurements and uploading the measurements to a server, making them available to interested parties.

In yet another embodiment of the invention, an apparatus/system may include an array of sensors disposed along the exhaust pipe of a vehicle with an ICE. A processor may be connected to the array of sensors. The processor may use input information from the array of sensors to determine flow rate values for the first fuel and the second fuel to achieve one or more goals regarding the presence of one or more exhaust products. The processor, in turn, may be connected to a first and second control disposed along the fuel lines of the first and second fuel to control the flow rates of the fuels.

The apparatus/system may also include a Global Positioning System (GPS) and a position to gravity sensor, providing additional information to the processor and a pyrometer providing exhaust temperature information to the processor. The processor may be disposed to interrupt the connection from an oxygen sensor to an electronic control unit controlling the flow rate of the first fuel to alter the information about oxygen levels to control the flow rate of the first fuel. The apparatus may also include a memory to record measurements and a transmitter to upload measurements to a server where they would be available to interested parties.

In certain embodiments, the processor may include an increase module that determines an amount by which to increase the flow rates of the two fuels. The processor may also include a relay module to relay information, including information about flow rates, to control units. Additionally, the processor may include a record module to record measurements of the exhaust products into memory and to access the measurements from memory. In some embodiments, the processor may also include an intercept module to alter oxygen readings from an oxygen sensor to achieve desired flow rates for the first fuel.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not, therefore, to be considered limiting of its scope, the invention will be described and explained with additional specificity and detail through use of the accompanying drawings, in which:

FIG. 1 is a schematic drawing of one embodiment of an apparatus to measure, record, and control exhaust products in real time as it may be affixed to the engine and exhaust system of a vehicle with an ICE;

FIG. 2 is a schematic drawing of another embodiment of an apparatus to measure, record, and control exhaust products in real time that includes additional sensors to assess position, acceleration, throttle position, exhaust temperature and additional connections to override an oxygen-sensor based first fuel control, as the apparatus may be affixed to the engine and exhaust system of a vehicle with an ICE;

FIG. 3 is a high-level block diagram showing one embodiment of the processor and memory used in the apparatus, method, and system used to measure, record, and control exhaust products in real time;

FIG. 4 is a flow chart of one embodiment of a method to measure, record, and control exhaust products in real time;

FIG. 5 is a flow chart of another embodiment of a method to measure, record, and control exhaust products in real time that incrementally increases the ratio of the second fuel to the first fuel, makes comparisons between measurements to determine whether a desired exhaust-product goal has been achieved, and evaluates exhaust temperature measurements as a safety precaution;

FIG. 6 is a flow chart of another embodiment of a method similar to the method in FIG. 5, but which also uses calibration information to determine increments by which to increase the ratio of a second fuel to the first fuel; and

FIG. 7 is a flow chart of one embodiment of a method similar to the methods in the previous Figures, but which also interrupts an oxygen sensor to override a first fuel control.

### DETAILED DESCRIPTION

The components of the present invention, as described in with reference to the Figures herein, could be arranged and designed in a wide variety of different configurations. Thus, the detailed description of the embodiments of the invention that follows is not intended to limit the scope of the invention, but rather to provide certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, of method. Elements of the present invention may combine hardware and software components (including firmware, resident software, micro-code, etc.) in their embodiment that may all generally be referred to herein as a “module.” A module may be realized on a combination of one or more computer-usable or computer-readable medium(s) may be utilized. Without limitation, the computer-usable or computer-readable medium may be an electronic, magnetic, optical, electromagnetic, infrared, or semiconductor system, apparatus, device, or propagation medium.

The module may also embody computer program code for carrying out operations. The code may be written in any combination of one or more programming languages, including an object-oriented programming language such as Java, Smalltalk, C++ or the like and conventional procedural programming languages, such as the “C” programming language or similar programming languages.

The present invention is described below with reference to flowchart illustrations and/or block diagrams of a method, apparatus, and systems according to embodiments of the invention. Each block of the flowchart illustrations and/or block diagrams, and combinations of blocks in the flowchart illustrations and/or block diagrams, may be implemented by computer program instructions or code. These computer program instructions may be implemented on a processor or other programmable data processing apparatus to produce a machine, such that the instructions, which execute via the processor of the computer or other programmable data processing apparatus, create means for implementing the functions/acts specified in the flowchart and/or block diagram block or blocks.

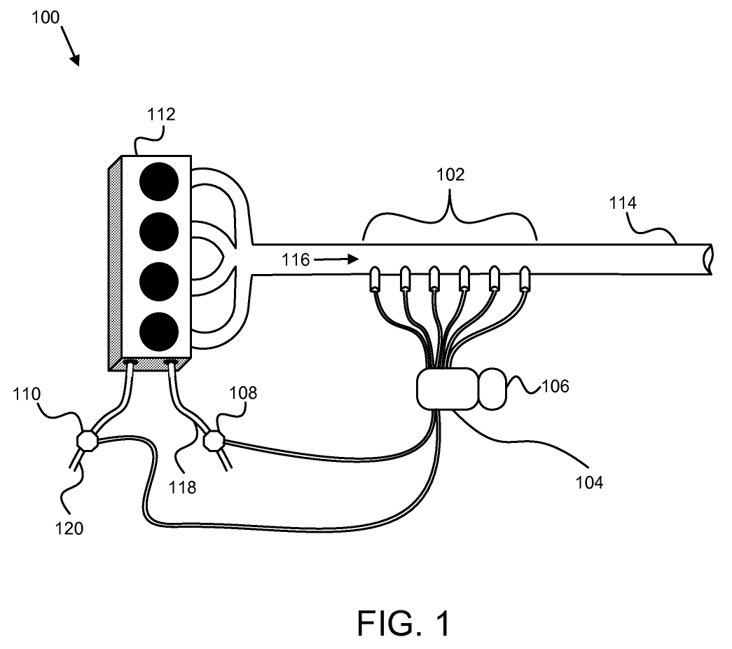

FIG. 1 depicts one embodiment of an apparatus/system 100 in accordance with the present invention. In the illustrated embodiment, the apparatus/system 100 includes an array of exhaust product sensors 102, a processor 104, a memory 106, a first fuel control unit 108, and a second fuel control unit 110. These elements work together to measure, record, and control, exhaust products from an ICE 112.

The array of exhaust product sensors 102 is affixed along the exhaust pipe 114 of an ICE 112. The individual sensors of the array 112 are disposed inside the exhaust pipe so that the exhaust 116 flows over them. In FIG. 1, six sensors are depicted. However, a larger or smaller number of sensors is also possible. Individual sensors may be keyed to individual exhaust products, or they may work in concert to measure these exhaust products, which may include, without limitation, CO, CO₂, NO, NO₂, SO₂, benzene, various PAFs, additional hydrocarbons, and particulate matter.

The sensors may be implemented as Non-dispersive Infra-red (NDIR) sensors, or sensors that use different regions of the electromagnetic spectrum, such as ultraviolet wavelengths for SO₂ detection. Additional sensing mechanisms may also play a role. Such sensors may include chemical and electrochemical based sensors. The array of sensors 102 is communicatively coupled, whether by wire or other means, to the processor 104 to deliver real time measurements of the exhaust products.

The processor 102 analyzes the information from the array of sensors 102 by implementing one or more of various algorithms to determine the proper flow rates of the first fuel and of the second fuel. The fuel rates are determined to achieve one or more goals concerning the presence of one or more exhaust products in the exhaust. The goal or goals may include limiting one or more exhaust products to a predetermined level. The goal or goals may also include limiting one or more exhaust product to the lowest possible level.

In certain embodiments, the processor 104 implements algorithms that rely on principals of probability law and/or Bayesian logic to determine appropriate flow rates. In alternative embodiments, the processor 104 implements algorithms that rely on comparisons between recent measurements stored in the memory 106, which is communicatively coupled to the processor 104. The processor 104 may implement additional types of algorithms.

The first fuel may be, but is not limited to, diesel or gasoline. The second fuel may be one of many alternative fuels, including but not limited to natural gas, both compressed and liquid, propane, hydrogen, liquid nitrogen, compressed air, hydrogen enhanced fuels, biomass fuels, and alcohol fuels. The second fuel tends to produce fewer harmful byproducts.

The processor 104 is communicatively coupled to a first control unit 108 and a second control unit 110. The first control unit 108 and the second control unit 110 are disposed, respectively, along the first fuel line 118 and the second fuel line 120 to control the flow rates of the first fuel and the second fuel. The processor 104 relays values for flow rates for the first and second fuel to the first control unit 118 and the second control unit 120, respectively, which are then implemented by the first control unit 118 and the second control unit 120, to control the first fuel flow rate and the second fuel flow rate, thereby controlling the exhaust products.

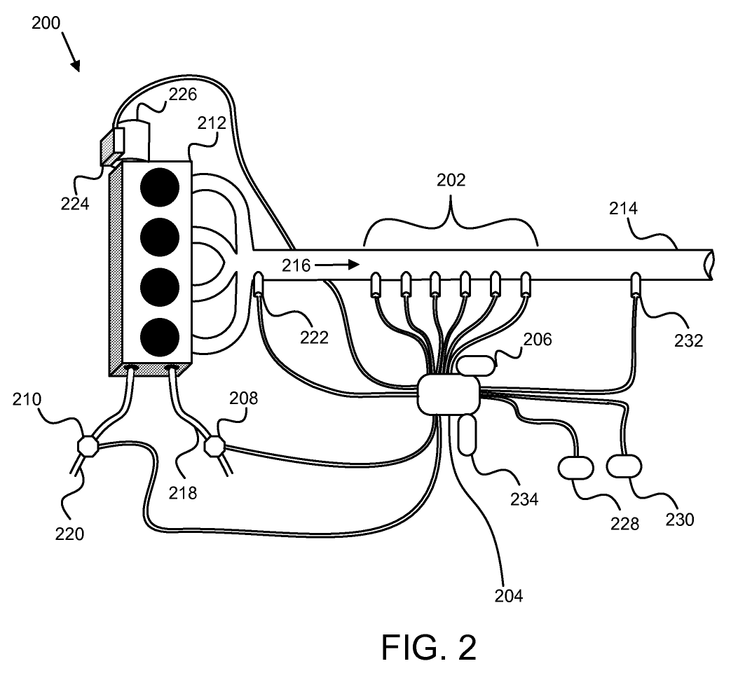

FIG. 2 depicts another embodiment of an apparatus/system 200 in accordance with the present invention. In the illustrated embodiment, the apparatus/system 200 includes an array of exhaust product sensors 202, a processor 204, a memory 206, a first fuel control unit 208, and a second fuel control unit 210 substantially similar to those described above with respect to FIG. 1. As in FIG. 1, these elements work together to measure, record, and control, exhaust products of an ICE 212. As before, the processor 204, uses measurements collected from the exhaust pipe 214 of exhaust 216 to determine and relay flow rates for a first and second fuel to a respective first control unit 208 and a second control unit 210 disposed along a respective first fuel line 218 and a second fuel line 220.

Additionally, the apparatus/system 200 may include a pyrometer 222 disposed near the ICE 212 to measure the temperature of the exhaust 216 from the ICE 212. In certain embodiments, a pre-existing pyrometer 222 may, or may not, be tapped into. Alternative fuels from which the second fuel may be selected are known to increase the temperatures within engines and exhaust systems, even to the point of becoming harmful to the engine and surrounding elements. The processor 204, which is communicatively connected to the pyrometer 222, may use exhaust temperature information to determine if a safety threshold has been crossed, approached, or the rate at which the threshold is being approached to determine appropriate flow rates for the second fuel.

Similarly, the apparatus/system 200 may include a throttle position sensor (TPS) 224 disposed along the throttle 226 to determine the amount of air being introduced to the ICE 212. In the presence of too much air, alternative fuels, from which the second fuel is selected, may also increase the temperature within engines and exhaust systems. As with the pyrometer 222, the processor 204, which is communicatively connected to the TPS 224, may use TPS 224 information to determine if a safety threshold has been crossed, approached, or the rate at which the threshold is being approached to determine appropriate flow rates for the second fuel.

The apparatus/system 200 may also include a GPS 228 and a position to gravity sensor 230 communicatively coupled to the processor 204, either of which may, or may not, be pre-existing to the vehicle. The GPS 228 and the position to gravity sensor 230 may provide the processor 204 acceleration and incline information that are relevant to engine loads and the proper flow rates for the first and second fuels, as determined by the processor 204.

In certain embodiments, the apparatus/system 200 may include an oxygen sensor 232, which may, or may not, be pre-existing to a vehicle, communicatively coupled to the processor 204. The processor 204 uses information about the level of oxygen in the exhaust 216 to produce a false oxygen reading with which to control the flow rate of the first fuel. In such embodiments, the first control unit 208 along the first fuel line 218 is a pre-existing electronic control unit that uses information about oxygen in the exhaust 216 from the oxygen sensor to determine the proper flow rate for the first fuel to achieve the stoichiometric balance between oxygen and the first fuel, as required for efficient engine operation. The processor 204 relays the false oxygen reading to the first control unit 208, thereby controlling the flow rate of the first fuel in accordance with the goal-appropriate, first-fuel-rate value determined by the processor 204.

Additionally, the apparatus/system 200 may also include a transmitter 234 communicatively coupled to the processor 204. The transmitter 224 is configured to upload measurements and/or records from the memory 206 and/or the processor 204 to a server (not shown). The server is configured to make the measurements and/or records accessible to predetermined, interested parties. Such parties may include, without limitation, the EPA and the driver/owner of a bi-fuel vehicle to which the apparatus/system 200 is attached.

Without limitation, the apparatus/system 100/200 in FIG. 1 or in FIG. 2, as with alternative embodiments, may be installed by a vehicle manufacture, or the manufacture of another device that runs on an ICE, as a original equipment manufacturer (OEM). The apparatus/system 100/200 in FIG. 1 or in FIG. 2, as with alternative embodiments may also be installed at a later point in time as an “add on.”

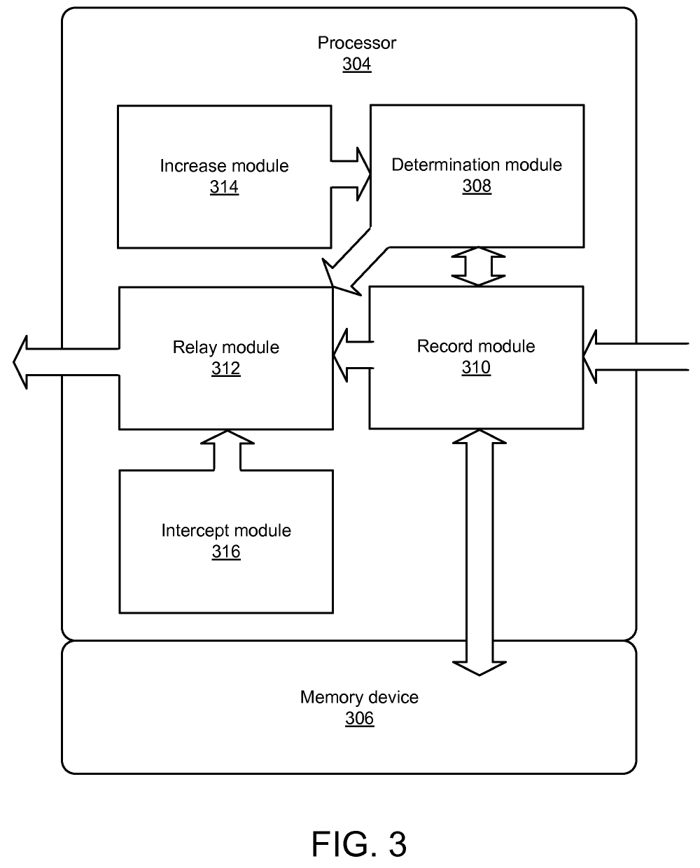

FIG. 3 depicts an embodiment of a processor 304 substantially similar to the processor 102/202 in FIG. 1 and FIG. 2, in accordance with present invention. The processer 304 is communicatively coupled to a memory device 306. The processor 304 includes a determination module 308, a record module 310, a relay module 312, an increase module 314, and an intercept module 316. Collectively, these elements work together to determine appropriate flow rates of a first and a second fuel, based on measurements of exhaust products, and to relay these flow rates to control units 108/208 and 110/210 to control those products, also, in some embodiments, to relay information about these measurements for further distribution.

In certain embodiments, the record module 310 receives, in real time, measurement information about exhaust product levels that is accessed by the determination module 308. In alternative embodiments, the determination model 308, or some other module receives the information. Several different architectures are possible.

At some point, the record module 310 records the real time measurement information in the memory device 306. Those skilled in the relevant art will recognize that there are many different formats possible for records of the real time measurements. The record module may also retrieve records and/or particular measurement information from the memory device to be relayed by the relay module 312 or analyzed by the determination module 308.

In certain embodiments, the determination module 308 applies one or more algorithms to the measurement information to determine proper flow rates for one or both of the two fuels. In certain embodiments, the determination module 308 applies probability laws and/or Bayesian logic to determine flow rates likely to achieve one or more goals with respect to one or more exhaust products given current exhaust product levels and, possibly, also given a current flow rate or given current flow rates. In alternative embodiments, the determination module 308 applies the comparison algorithm discussed above with respect to FIG. 1 to determine when to stop increasing the flow rate of the second fuel. In such embodiments, the increase module 314 may determine the amount by which the second fuel flow rate is incrementally increased at each increment of increase based on calibration data particular to the particular ICE with which the processor is associated. Other possible algorithms may also be applied.

The relay module 312 is configured to relay flow rates, as determined by the determination module 308, to control units 108/208 and 110/210 substantially similar to those described in connection with FIG. 1 and FIG. 2. The relay module 314 is also configured to relay measurements, either in real time, or particular measurements and/or records from the memory device 306 to the transmitter 234 for transmission to a server (not shown) where the measurements and/or records can be accessed in near real time or at some other time by interested parties. Such parties, without limitation, may include the EPA or the operator of the ICE with which the processor 304 is associated. In certain embodiments, the relay module may also relay a false oxygen reading to the first control unit 108/208 from the intercept module 316.

The intercept module 316 determines a false oxygen level likely to cause a first control unit 108/208 to insure a first-fuel flow rate that matches the first-fuel flow rate determined by the determination module 308 or that is consistent with the second fuel rate as determined by the determination module 308 or increase module 316. In certain embodiments, the intercept module uses readings sent to the processor 304 from an oxygen sensor 232 substantially similar to the one in FIG. 2 to create the appropriate false oxygen reading.

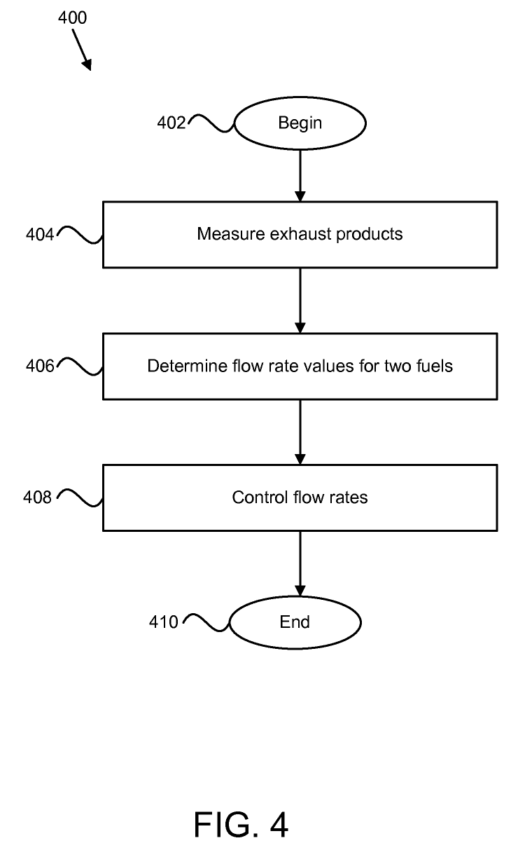

FIG. 4 is a flow chart illustrating one embodiment of an exhaust product control method 400 in accordance with the present invention. The method 400 begins 402 by measuring 404 exhaust products from an ICE. The method 400 continues by determining 406 flow rate values for the two fuels being supplied to the ICE to control one or more exhaust products of that engine in keeping with one or more exhaust-product specific goals, where the determination is made, at least in part, on the basis of the current exhaust product measurements. After controlling the flow rates of the two fuels in accordance with the determined flow rate values, the method 400 comes to an end 410.

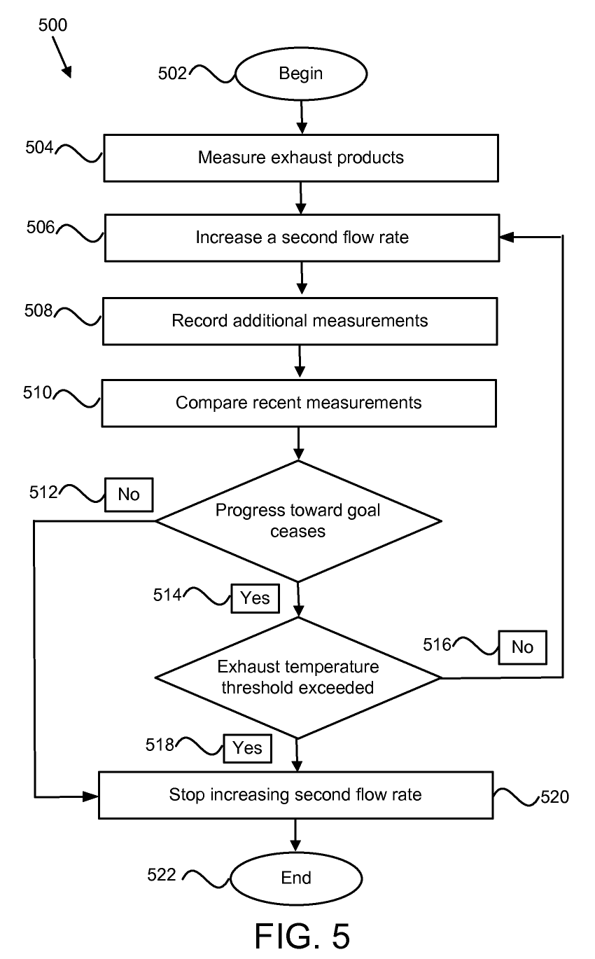

FIG. 5 is a schematic flow chart diagram illustrating another embodiment of an exhaust product control method 500 that relies on comparisons between recent measurements of exhaust products, in accordance with the present invention. The method 500 begins 502, as in FIG. 4, by measuring 504 the exhaust products of an ICE. The flow rate of a second fuel being supplied to an ICE is then increased 506. After the increase 506, additional measurements of exhaust products are recorded 508. The method 500 continues by comparing 510 recent measurements both before and after the increase 506.

If progress is not being made 512 toward a goal related to one or more exhaust products, the method 500 stops 520 increases to the second flow rate and the method 500 ends 522. However, if progress is being made 514, in certain embodiments, a determination is made with respect to exhaust temperature. If the exhaust temperature does not exceed a certain threshold 516, then the method 500 continues by again increasing 506 the flow rate of the second fuel, recording 508 additional measurements, and making another comparison 510. Conversely, if the exhaust temperature does exceed the threshold 518, the method 500 stops 520 increases to the second flow rate and the method 500 ends 522.

The method 500 may begin 502 again at varying time intervals after it has ended 522 to keep pace with varying engine loads and changing exhaust products. The determination as to exhaust temperature is an optional safety precaution that need not be employed in all embodiments. In embodiments where it is not employed, after the comparison 510, if progress is not being made toward a goal related to at least one exhaust product, increases of the second flow rate are stopped 520 and the method 500 ends 522. If progress is being made, the steps of increasing 506 the second fuel, recording 508 additional measurements, and comparing 510 recent measurements are repeated.

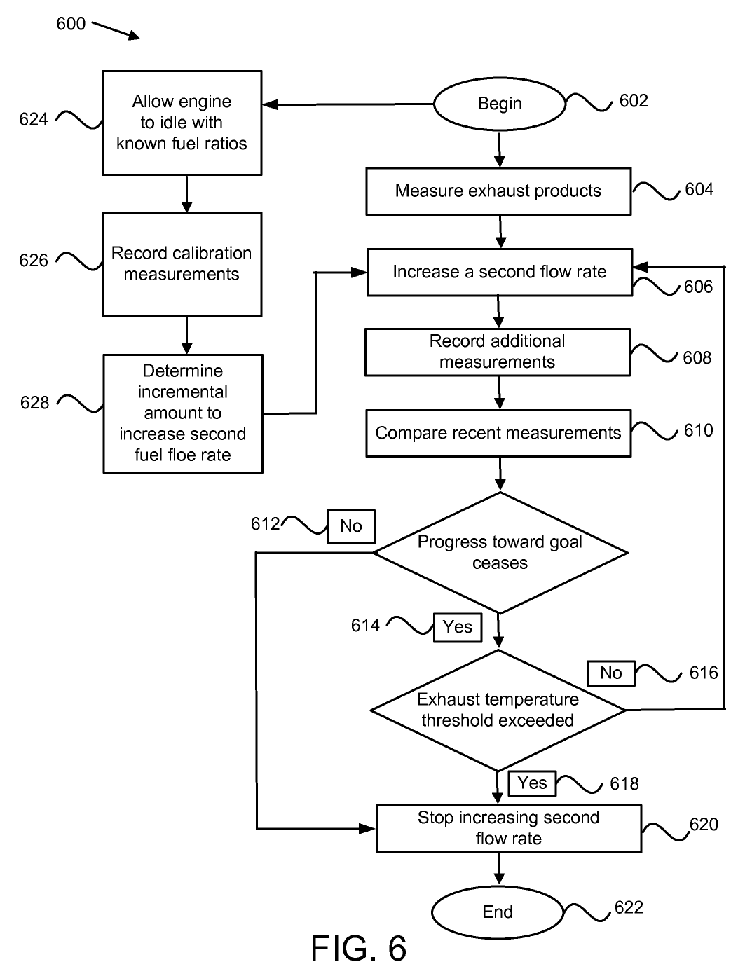

FIG. 6 is a flow chart illustrating another embodiment of an exhaust product control method 600 that relies on engine-specific calibration information to determine increments by which to increase the flow rate of the second fuel, in keeping with the present invention. The method 600 begins 602 and proceeds along lines substantially similar to those of the method 500 explained with respect to FIG. 5. However, at some time before the first increase 606 of the second flow rate is made, a series of steps are performed.

The first of these steps is to allow 624 an ICE to idle with a known ratio of a first and a second fuel being feed to the ICE. The next step is to record 626 measurements of exhaust products once those exhaust products have stabilized. These first two steps of allowing 624 an ICE to idle with a known fuel ratio and recording 626 measurements of exhaust products may be repeated many different times for different ratios of a first and a second fuel, including a scenario where the supplied fuel consists only of the first fuel. These records then serve as calibration points. The calibration products are specific to the ICE for which they are made and may be recorded whenever the present invention is installed, whether at the factory or by a qualified technician when the invention is installed as an “add on.”

The next step is then to determine 628 an incremental amount by which to increase the flow rate of the second fuel based on the calibration points. In certain embodiments, the determination may also be made based on real time measurements of exhaust products. The incremental amount can vary from one increase to another depending on exhaust products.

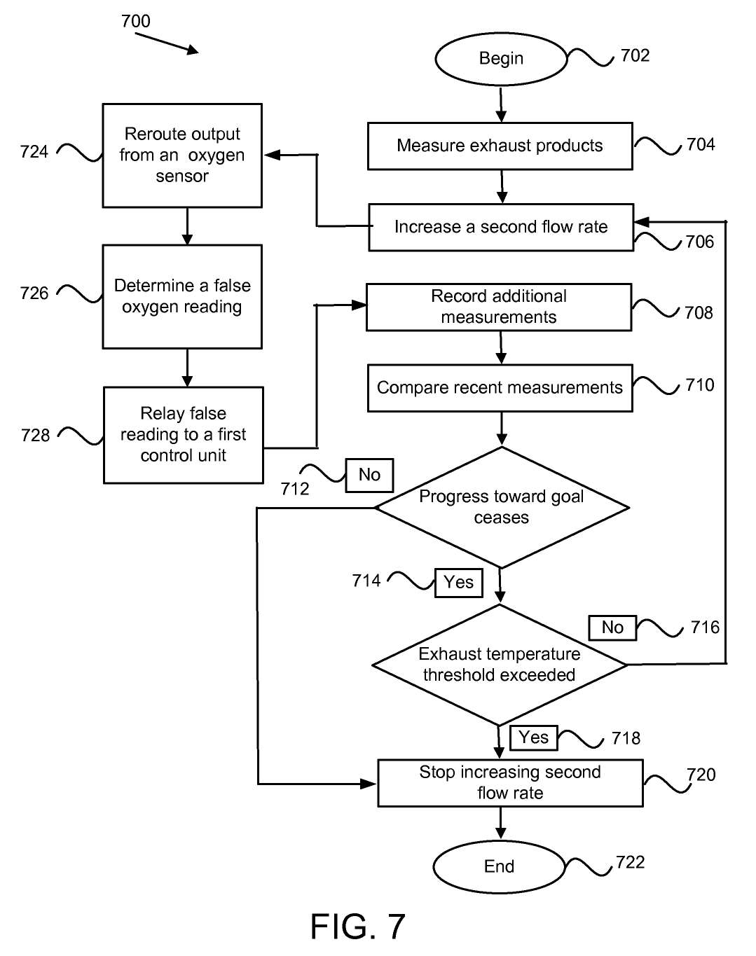

FIG. 7 is a flow chart illustrating another embodiment of an exhaust product control method 700 that involves falsifying oxygen readings to control the flow rate of a first fuel, in keeping with the present invention. The method 700 begins 702 and proceeds along lines substantially similar to those of the method 500 explained with respect to FIG. 5. However, between the steps of increasing 706 a second flow rate and recording 708 additional measurements, certain additional steps are taken to insure that the flow rate of the first fuel is changed to allow for the increasing flow rate of the second fuel.

These steps commandeer a control system for the first fuel that is already pre-existing in many exhaust and fuel intake systems. Many exhaust systems are designed to include an oxygen sensor 232 similar to that described in relation to FIG. 2. This oxygen sensor 232 is communicatively coupled to an electrical control unit that severs as a first control unit 208 to control the flow rate of the first fuel. The control unit 208 uses readings about the presence of oxygen in the exhaust to determine how much of the first fuel to allow to flow to the engine so that a proper stoichiometric relationship between oxygen and fuel is achieved to insure complete combustion. The oxygen sensor 232 may be added in situations where it is not already present.

The first of these commandeering steps is to reroute 724 the output of the oxygen sensor. In certain embodiments, the output from the oxygen sensor is rerouted to a processor 104/204/304. In alternative embodiments, it is simply disconnected. The next step is to determine 726 a false oxygen reading. In some embodiments, the false reading is determined so as to cause the first control unit 208 to control the flow rate of the first fuel so that is consistent with an increase in the second fuel. In some embodiments the output of the oxygen sensor 232 is used to determine the false oxygen reading.

The next step is to relay 728 the false oxygen reading to the control unit 108/208 to control the actual flow rate of the first fuel. These commandeering steps are not unique to methods such as those described in relation to FIG. 5 and FIG. 6 that make comparisons of exhaust measurements to determine when to stop increasing the flow rate of a second fuel. They may also be used to implement the control step 408 of the method 400 described in relation to FIG. 4. In such embodiments, the false reading is determined so as to cause the first control unit 208 to control the flow rate of the first fuel so that it is consistent with an exhaust-product-goal-achieving flow rate determined by a processor 104/204/304.

The architecture, functionality, and operation of possible implementations of the method, apparatus, and system in certain embodiments, flowcharts and block diagrams in the Figures are not exhaustive of the possible embodiments of the present invention. Additionally, each block in the flowcharts or block diagrams may represent a module, segment, or portion of code, which comprises one or more executable instructions for implementing the specified logical function(s). Therefore, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved.

1. A method comprising:
measuring, in real time, exhaust products from an internal combustion engine (ICE);
determining flow rate values for a first fuel and for a second fuel, from measurements of said exhaust products, to achieve at least one goal regarding at least one exhaust product in exhaust from said ICE; and
controlling flow rates of said first fuel and of said second fuel to match said flow rate values determined from said measurements.

2. The method of claim 1, wherein determining flow rate values comprises:
increasing a second flow rate for said second fuel relative to a first flow rate of said first fuel;
recording additional measurements of said exhaust products;
comparing said additional measurements to a previous set of measurements; and
repeating the steps of increasing said second flow rate, recording additional measurements, and comparing said additional measurements until a single end outcome occurs, wherein said end outcome is selected from the group comprised of a cessation in progress toward at least one goal regarding at least one exhaust product and an indication from a pyrometer that a temperature of said exhaust from said ICE has exceeded an acceptable level.

3. The method of claim 2, further comprising:
allowing a particular ICE to idle while running on at least one fuel supply selected from the group comprising just said first fuel, just said second fuel, a known mixture of said first fuel and said second fuel;
recording measurements of exhaust products for said at least one fuel supply as calibration points for said particular ICE; and
determining an incremental amount by which to increase said second fuel based on said calibration points.

4. The method of claim 2, wherein controlling flow rates of said first fuel and of said second fuel comprises;
rerouting the output from an oxygen sensor to a processor used to determine said flow rate values;
determining, within said processor, a false oxygen reading that will cause a control unit controlling a first flow rate of said first fuel to match said first flow rate value determined by said processor;
relaying said false oxygen reading to said control unit; and
relaying data indicating said second flow rate value, as determined by said processor, to a second control unit controlling a second flow rate of said second fuel.

5. The method of claim 1, further comprising storing a record of measurements of said exhaust products.

6. The method of claim 5, further comprising uploading measurements of said record to a server for further distribution.

7. An apparatus comprising:
an array of sensors disposed in an exhaust pipe downstream from an internal combustion engine (ICE);
a processor communicatively coupled to said array of sensors, determining flow rate values for a first fuel and for a second fuel, from measurements of exhaust products coming from said array of sensors, to achieve at least one goal regarding at least one exhaust product in exhaust from said ICE; and
a first control unit communicatively coupled to said processor and disposed along a first fuel line to control a flow rate of said first fuel in accordance with said first flow rate value communicated from said processor; and
a second control unit communicatively coupled to said processor and disposed along a second fuel line to control a flow rate of said second fuel in accordance with said second flow rate value communicated from said processor.

8. The apparatus of claim 7, further comprising a memory communicatively coupled to said processor, maintaining a record of said measurements of said exhaust products.

9. The apparatus of claim 8, further comprising an oxygen sensor communicatively coupled to said processor, said processor including and intercept module configured to alter oxygen readings from said oxygen sensor to cause said first control unit to control said flow rate of said first fuel to match said first flow rate value determined by said processor.

10. The apparatus of claim 7, further comprising a transmitter communicatively coupled to said processor, transmitting data from said memory to a server for further distribution.

11. A system comprising:
an array of sensors disposed in an exhaust pipe downstream from an internal combustion engine (ICE);
a pyrometer disposed downstream from said ICE;
a memory;
a processor communicatively coupled to said array of sensors further comprising:
an increase module determining an amount by which to increase a second flow rate of a second fuel relative to a first flow rate of a first fuel,
a record module recording measurements of said exhaust products in said memory communicatively coupled to said processor after each increase of said second fuel,
a determination module comparing most recent measurements to previous measurements to determine when an end outcome occurs, wherein said end outcome is selected from the group comprising a cessation in progress toward at least one goal regarding at least one exhaust product and an indication from said pyrometer that a temperature of said exhaust from said ICE has exceeded an acceptable level;
a relay module relaying information about changes in flow rate and to relay said measurements to a transmitter;
a first control unit communicatively coupled to said processor and disposed along a first fuel line to control a flow rate of said first fuel in accordance with a flow rate relayed from said processor; and
a second control unit communicatively coupled to said processor and disposed along a second fuel line to control a flow rate of said second fuel in accordance with a flow rate relayed from said processor.

12. The system of claim 11, further comprising a transmitter communicatively coupled to said processor, transmitting data from said memory to a server for further distribution.
